(19) United States
(12) Patent Application Publication
(10) Pub. No.: US 2007/0293186 A1
(43) Pub. Date: Dec. 20, 2007

(54) Systems and Methods for a Personal Safety Device

(75) Inventor: Paul V. Lehmann, Cleveland Heights, OH (US)

Correspondence Address: BORSON LAW GROUP, PC, 1320 WILLOW PASS ROAD, SUITE 490, CONCORD, CA, 94520-5232, US

(73) Assignee: CTL ANALYZERS, LLC, Cleveland, OH (US)

(21) Appl. No.: 10/589,186

(22) PCT Filed: Feb. 9, 2005
(86) PCT No.: PCT/US05/04256

§ 371 Date: Jul. 30, 2007

Related U.S. Application Data
(60) Provisional application No. 60/543,500, filed on Feb. 11, 2004.
(60) Provisional application No. 60/544,485, filed on Feb. 12, 2004.

(51) Int. Cl. H04M 11/04

(52) U.S. Cl. 455/404.2

(57) ABSTRACT

Embodiments include systems and methods for summoning help and locating a person, comprising transmitting information over a wireless network in response to a user action; wherein the information includes the geographic location of the user.

### PRIORITY CLAIM

This application claims priority to U.S. Provisional Patent Application Ser. No: 60/543,500 titled “Systems and Methods for a Personal Safety Device,” Paul Lehmann, Inventor, filed Feb. 11, 2004 (Attorney Docket No: CLTL 1007 US0 DBB) and to U.S. Provisional Patent Application Ser. No: 60/544,485 titled “Systems and Methods for a Personal Safety Device,” Paul Lehmann Inventor, filed Feb. 12, 2004 (Attorney Docket No: CLTL 1007 US1 DBB). The above applications are incorporated herein fully by reference.

### FIELD OF THE INVENTION

The present disclosure relates generally to portable personal safety devices that utilize the Global Positioning System (GPS) or other systems to determine geographic location. Particularly, this invention relates to personal safety devices with integrated cameras, sound recorders, and/or biometric authentication mechanisms.

### BACKGROUND

Personal safety devices have contributed to improving the ability of persons to remain safe when faced with potentially hazardous conditions. For example, GPS systems can be used to provide information about a person's location relative to satellites. Additionally, devices such as mobile telephones, or mobile telephone networks, such as cellular telephones and/or other radio transceivers can be used to make contact with authorities or rescuers if an individual is lost. User-specific devices include whistles, flares, which can be used to alert passersby to imminent danger to an individual, through, for example assault by another. Further, certain specific signals (e.g., transponder) can be used to identify a sending device and its location. Such transponders have wide use in the navigation arts, including aerospace, shipping, and in some cases, automobiles.

Current personal GPS devices that are worn or carried allow an individual's location to be tracked and, in some cases, allow help to be summoned in an emergency by transmitting the current location of the individual to providers of emergency services. However, these systems fail to convey potentially valuable information such as a voice message, an image and/or a movie/video. For example, this information could be useful in identifying a criminal suspect or for determining what type of emergency response (e.g., police, ambulance, fire) is appropriate. Another drawback of current systems is that they fail to integrate other common portable devices, such as cell phones and PDAs (Personal Digital Assistants). Having one more electronic device to carry reduces the likelihood that an individual will use it.

### BRIEF DESCRIPTION OF THE FIGURES

This invention is described with respect to certain embodiments thereof. Other aspects of this invention can be understood with reference to the drawings, in which:

FIG. 1 is an exemplary illustration of a personal safety device (PSD) in accordance to certain embodiments of the invention.

FIG. 2 is an exemplary personal safety device information relay system in accordance to certain embodiments of the invention.

FIG. 3 is an illustration of an exemplary user interface in accordance to certain embodiments of the invention.

FIG. 4 is an exemplary illustration of a personal safety device system in accordance to certain embodiments of the invention.

### DETAILED DESCRIPTION

### Definitions

In general, the following words or phrases or abbreviations have the indicated definitions when used in the description examples and claims:

As used herein, “API” stands for Application Program Interface.

As used herein, “ATM” stands for Asynchronous Transfer Mode.

As used herein, “CD-ROM” stands for Compact Disc Read Only Memory.

As used herein, “cellular telephone” includes portable, self-contained digital and/or analog telephones, text messaging devices, telecommunication devices and two-way radios.

As used herein, “DRAM” stands for Dynamic Random Access Memory.

As used herein, “DVD” stands for Digital Video Disc.

As used herein, “EEPROM” stands for Electrically Erasable Programmable Read-only Memory.

As used herein, “EPROM” stands for Erasable Programmable Read-only Memory.

As used herein, “GPS” stands for Global Positioning System.

As used herein, “GSM” stands for Global System for Mobile Communications.

As used herein, “GUI” stands for Graphical User Interface.

As used herein, “HTML” stands for Hypertext Markup Language.

As used herein, “HTTP” stands for Hypertext Transfer Protocol.

As used herein, “HTTPS” stands for Hypertext Transfer Protocol over Secure Socket Layer.

As used herein, “IC” stands for Integrated Circuit.

As used herein, “IP” stands for Internet Protocol.

As used herein, “JMS” stands for Java® Message Service.

As used herein, “mobile telephone” means a mobile transmitter/receiver, including but not limited to a cellular telephone.

As used herein, “mobile telephone network” means a system of transmitters/receivers and relay stations enabling wireless communication of voice and/or data signals.

As used herein, “MPEG-4” stands for Motion Picture Experts Group Four.

As used herein, “PDA” stands for Personal Digital Assistant.

As used herein, “POP” stands for Post Office Protocol.

As used herein, “PSD” stands for Personal Safety Device.

As used herein, “RAM” stands for Random Access Memory.

As used herein, “ROM” stands for Read Only Memory.

As used herein, “SOAP” stands for Simple Object Access Protocol.

As used herein, “TCP/IP” stands for Transmission Control Protocol/Internet Protocol.

As used herein, “UDP” stands for User Datagram Protocol.

As used herein, “UMTS” stands for Universal Mobile Telecommunication System.

As used herein, “UI” stands for User Interface.

As used herein, “VoIP” stands for Voice Over Internet Protocol.

As used herein, “VRAM” stands for Video Random Access Memory.

As used herein, “Wi-Fi” stands for “wireless fidelity” or wireless local area network.

As used herein, a “wireless local area network” or “wireless LAN” means a data communications network that is associated with a defined geographic area, for example, a cell of a cellular network or a Wi-Fi coverage area.

As used herein, a “wireless wide-area network” or “wireless WAN” means a data communications network that is associated with a defined geographic area that is typically larger than that of a wireless LAN.

As used herein, “XML” stands for “Extensible Markup Language”.

### General Description of Embodiments

Aspects of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

Personal safety devices of this invention include embodiments designed to provide rapid notification of an authority of a person's location, identification, time, and/or identity of another (e.g., a person causing a hazardous condition). In certain embodiments, a personal safety device can include a GPS receiver (or other means to determine geographic location), an activation device (e.g., a switch), a timing device to indicate the time of activation of the device, a personal identifier such as a digital signal, a transmitter to transmit information to a remote location such as a central monitoring station (e.g., police, parents etc) and a component to protect the device and system from tampering by non-authorized persons.

According to certain embodiments of the invention, a method is provided for summoning help, comprising: biometrically identifying a user; and transmitting information over a wireless network in response to a first user action,wherein the information includes the geographic location of the user. According to other embodiments of the invention, a method is provided for summoning help according to the method disclosed in the first sentence of this paragraph, a) wherein: the information includes at least one of text; a sound; an image; and a video/movie; or b) wherein: the information is transmitted by a device that is securely attached to the user; or c) wherein: a portable device is used to transmit the information; and wherein the portable device is integrated with at least one of a mobile telephone; a digital camera; a computer game; a digital music player; a personal digital assistant; and a GPS receiver. According to further embodiments of the invention, a method is provided for summoning help according to the method disclosed in the first sentence of this paragraph, further comprising: automatically summoning help in response to receipt of the transmitted information. According to still further embodiments of the invention, a method is provided for summoning help according to the method disclosed in the first sentence of this paragraph, a) wherein: a portable device is used to transmit the information, wherein the portable device can receive a message, and wherein the message can include at least one of text; a sound; an image; and a video/movie, or b) wherein: the information can be transmitted over at least one of a wireless local area network; a wireless wide area network; a cellular network; a satellite network; a Wi-Fi network; and a pager network. According to another set of embodiments of the invention, a method is provided for summoning help according to the method disclosed in the first sentence of this paragraph, a) further comprising: receiving the information; and rendering the information tamper-proof; or b) wherein: at least one of the following devices is activated in response to a second user action: a sound recorder; an image recorder; and a video/movie recorder.

According to certain embodiments of the invention, a method is provided for summoning help, comprising: transmitting information over a wireless network in response to a first user action; wherein the information includes the geographic location of a user; and wherein the information can include at least one of text information; sound information; image information; and video/movie information. According to further embodiments of the invention, a method is provided for summoning help according to the method disclosed in the first sentence of this paragraph, a) further comprising biometrically identifying the user; or b) wherein said information is transmitted by a device that is securely attached to the user; or c) wherein a portable device is used to transmit the information; and wherein the portable device can be integrated with at least one of a mobile telephone; a digital camera; a computer game; a digital music player; a personal digital assistant; and a GPS receiver; or d) further comprising automatically summoning help in response to receipt of the transmitted information. According to other embodiments of the invention, a method is provided for summoning help according to the method disclosed in the first sentence of this paragraph, a) wherein: a portable device is used to transmit the information; wherein the portable device can receive a message; and wherein the message can include at least one of text; a sound; an image; and a video/movie; or b) wherein the information can be transmitted over at least one of: a wireless local area network; a wireless wide area network; a cellular network; a satellite network; a Wi-Fi network; and a pager network; or c) further comprising: receiving the information; and rendering the information tamper-proof; or d) wherein: at least one of the following devices is activated in response to a second user action: a sound recorder; an image recorder; and a video/movie recorder.

According to other embodiments of the invention, a method is provided for locating a person, comprising: accepting information from a portable device on the person wherein the information includes a current location of the person; providing the information to a user interface wherein the user interface can depict the geographic location of the person, wherein the user interface can depict a predicted travel path of the person based on the information. According to further embodiments of the invention, a method is provided for locating a person as disclosed in the first sentence of this paragraph, a) wherein: the information includes at least one of text; a sound; an image; and a video/movie; or b) wherein: the portable device can be integrated with at least one of a mobile telephone; a digital camera; a computer game; a digital music player; a personal digital assistant; and a GPS receiver; or c) further comprising automatically summoning help in response to receipt of the transmitted information; or d) further comprising: sending a message to the person via the portable device in response to user interaction with the user interface, wherein the message can include at least one of text; a sound; an image; and a video/movie. According to still further embodiments of the invention, a method is provided for locating a person as disclosed in the first sentence of this paragraph, wherein: the information can be transmitted over at least one of a wireless local area network; a wireless wide area network; a cellular network; a satellite network; a Wi-Fi network; and a pager network; or b) further comprising rendering the information tamper-proof; or c) further comprising automatically summoning assistance for the person in response to user interaction with the user interface; or d) further comprising remotely configuring the device from the user interface; or e) further comprising biometrically authenticating the person's identity.

According to further embodiments of the invention, a portable personal safety device (PSD) is provided, comprising: a location tracker capable of determining a current location of the PSD; a communication manager capable of transmitting information including the current location and at least one of text; a sound; an image; and a video/movie; and a monitor capable of causing the transmission in response to a user action. According to still further embodiments of the invention, a PSD is provided as disclosed in the first sentence of this paragraph, a) further comprising a biometric authenticator capable of authenticating the identity of a PSD user; or b) wherein the PSD will not operate unless the identity of a PSD user is authenticated; or c) wherein the communication manager is capable of transmitting and receiving information over at least one of the following networks a wireless local area network; a wireless wide area network; a cellular network; a satellite network; a Wi-Fi network; and a pager network. According to other embodiments of the invention, a PSD is provided as disclosed in the first sentence of this paragraph, a) further comprising means for securing the PSD to a person; or b) wherein the PSD can be integrated with at least one of: a mobile telephone; a digital camera; a computer game; a digital music player; a personal digital assistant; and a GPS receiver; or c) wherein the transmitted information is automatically relayed to a party that can provide assistance to a user of the PSD; or d) further comprising a system capable of receiving the transmitted information, wherein the system is capable of rendering the information tamper-proof.

According to other embodiments of the invention, a personal safety system is provided, comprising: a portable personal safety device (PSD) capable of transmitting a request for help in response to a user action wherein the request includes a current location of the PSD and at least one of: text; sound information; image information; and video/movie information; and a relay capable of accepting the request. According to still other embodiments of the invention, a PSD is provided as disclosed in the first sentence of this paragraph, a) wherein the PSD is capable of biometrically authenticating the identity of a PSD user; or b) further comprising a second system capable of receiving the request and rendering information in the request tamper-proof; or c) wherein the relay is capable of automatically summoning help based on the request. According to further embodiments of the invention, a PSD is provided as disclosed in the first sentence of this paragraph, wherein the relay is capable of automatically summoning help based on the request, wherein the relay is capable of using multiple communication paths to summon help. According to yet further embodiments of the invention, a PSD is provided as disclosed in the first sentence of this paragraph, a) wherein the relay is capable of rendering information in the request tamper-proof; or b) further comprising a user interface (UI). According to other embodiments of the invention, a PSD is provided as disclosed in the first sentence of this paragraph, further comprising a UI, a) wherein the UI graphically renders a current location and projected location of a PSD user; or b) wherein the UI is capable of sending a message to a PSD user via the PSD; or c) wherein the UI is capable of summoning help on behalf of a PSD user; or d) wherein the UI is capable of remotely configuring the PSD.

According to other embodiments of the invention, a machine readable medium is provided having instructions stored thereon that when executed by a processor causes a system to: transmit information over a wireless network in response to a first user action, wherein the information includes the geographic location of the user; and wherein the information can include at least one of text; sound information; image information; and movie/video information. According to still other embodiments of the invention, a machine readable medium is provided as disclosed in the first sentence of this paragraph, a) wherein: a portable device is used to transmit the information; and wherein the portable device can be integrated with at least one of a mobile telephone; a digital camera; a computer game; a digital music player; a personal digital assistant; and a GPS receiver; or b) further comprising instructions that when executed by a processor cause the system to: automatically summon help in response to receipt of the transmitted information; or c) wherein: a portable device is used to transmit the information; wherein the portable device can receive a message; and wherein the message can include at least one of text; a sound; an image; and a video/movie. According to further embodiments of the invention, a machine readable medium is provided as disclosed in the first sentence of this paragraph, a) wherein: the information can be transmitted over at least one of a wireless local area network; a wireless wide area network; a cellular network; a satellite network; a Wi-Fi network; and a pager network; or b) further comprising instructions that when executed by a processor cause the system to: receive the information; and render the information tamper-proof; or c) wherein: at least one of the following devices is activated in response to a second user action: a sound recorder; an image recorder; and a video/movie recorder.

According to other embodiments of the invention, a computer data signal is provided that is embodied in a transmission medium, comprising: a code segment including instructions to transmit information over a wireless network in response to a first user action; wherein the information includes the geographic location of the user; and wherein the information can include at least one of text; sound information; image information; and video/movie information. According to further embodiments of the invention, a computer data signal is provided as disclosed in the first sentence of this paragraph, a) wherein: the information is transmitted by a device that is securely attached to the user; or b) wherein: a portable device is used to transmit the information; and wherein the portable device can be integrated with at least one of: a mobile telephone; a digital camera; a computer game; a digital music player; a personal digital assistant; and a GPS receiver; or c) further comprising: a code segment including instructions to automatically summon help in response to receipt of the transmitted information; or d) wherein: a portable device is used to transmit the information; wherein the portable device can receive a message; and wherein the message can include at least one of text; a sound; an image; and a video/movie. According to still further embodiments of the invention, a computer data signal is provided as disclosed in the first sentence of this paragraph, a) wherein: the information can be transmitted over at least one of: a wireless local area network; a wireless wide area network; a cellular network; a satellite network; a Wi-Fi network; and a pager network; or b) further comprising: a code segment including instructions to receive the information; and a code segment including instructions to render the information tamper-proof; or c) wherein: at least one of the following devices is activated in response to a second user action: a sound recorder; an image recorder; and a video/movie recorder.

According to yet other embodiments of the invention, a personal safety device is provided, comprising: means for identifying a user; means for initiating a signal, wherein said signal comprises position of said device and one or more of: 1) a personal identifying characteristic; 2) a sound signal; 3) an image signal; and 4) a video/movie signal; and means for transmitting said signal. According to still other embodiments of the invention, a personal safety device is provided according to the first sentence in this paragraph, a) wherein said signal includes means for preventing tampering with said signal; or b) wherein said signal further comprises a time stamp; or c) further comprising means for warning.

According to other embodiments of the invention, a method for summoning help, is provided, comprising: means for biometrically identifying a user; means for transmitting information over a wireless network in response to a first user action, wherein the information includes means for locating the user.

According to still other embodiments of the invention, a system for summoning help is provided, comprising: a device comprising: an actuating component a signal for biometrically identifying a user; a signal for identifying the geographic position of said device; and a memory device for storing said signal for biometrically identifying and identifying the position of said device; a transmitter for transmitting information over a wireless network; and a receiver of said information. According to still further embodiments of the invention, a system for summoning help is provided as disclosed in the first sentence of this paragraph, a) wherein said information further comprises a time stamp; or b) wherein said device further comprises at least one of a sound receiver and a camera; or c) wherein said information is tamper-proof.

In additional aspects of the invention, at least one of the following devices is activated in response to a second user action: 1) a sound recorder; 2) an image recorder; 3) a video/movie recorder.

In still further embodiments, a portable device is used to transmit the information wherein the portable device can be integrated with at least one of: 2) a mobile telephone, such as a cellular telephone; 2) a digital camera; 3) a computer game; 4) a digital music player; 5) a personal digital assistant; and 6) a GPS receiver.

Additional aspects include automatically summoning assistance for the person in response to user interaction with the user interface.

Further embodiments include remotely configuring the device from the user interface.

Additionally, the transmitted information can be automatically relayed to a party that can provide assistance to a user of the PSD.

Additional aspects of the invention include a personal safety system, comprising a PSD capable of transmitting a request for help in response to a user action wherein the request includes a current location of the PSD and at least one of: 1) sound information; and 2) image information; and a relay capable of accepting the request.

In other embodiments, a PSD is capable of automatically summoning help based on the request.

In additional embodiments, a PSD is capable of using multiple communication paths to summon help.

### Detailed Description of Embodiments

A PSD is a portable device that an individual can use to summon help in an emergency. In some embodiments, a PSD can have a small form factor similar to that of a mobile telephone, such as a cellular telephone or a wristwatch. It can be easily carried or worn. If an individual with a PSD is accosted by a criminal or has a medical emergency, the PSD can be used to allow the individual to summon help with a simple action, such as the press of a button or a voice command. In certain embodiments, a voice recording system can be activated to record the user's or other's voices or other sounds associated with the events. In certain embodiments a device can record the individual's geographic location to another system that can automatically summon help on behalf of the individual. In addition, in some embodiments, a device can record visual images. This information, which could provide evidence in a criminal proceeding, can automatically be made tamper-proof and stored in a safe location.

In certain aspects, upon activation, a PSD can add a time-stamp to the signal along with sound, image and/or position received by the device from the user. In certain of these embodiments, activation can occur only by a pre-authorized user, who programs the device to respond only to user's possessing a pre-identified personal feature. In these embodiments, authentication can be by way of, for example only, fingerprint, voiceprint or other uniquely identifying feature of the user.

In other embodiments, upon activation, or after activation, the PSD can transmit user identification, time, location, an image/video/movie and/or other information remotely to a receiving station using a satellite system.

In additional embodiments, a PSD can include a “warning” device, such as a siren and/or a color-coded signal (e.g., a light signal) to alert passersby of potential harm to the user. Such a warning device can also be used to inform a perpetrator of a crime that the signal has been activated, and that authorities have been notified. Such a notification can include an image/video/movie of the potential perpetrator.

Transmission of signals can be formatted in tamper-proof fashion, for example, according to standards set forth by the 21 C.F.R. Part 11 which is incorporated herein by reference in its entirety. Files are transmitted to a satellite receiver and can be stored there and then made accessible to police, court or other authority that can handle the files in a tamper-proof fashion. Thus, information can be suitably reliable for court proceedings.

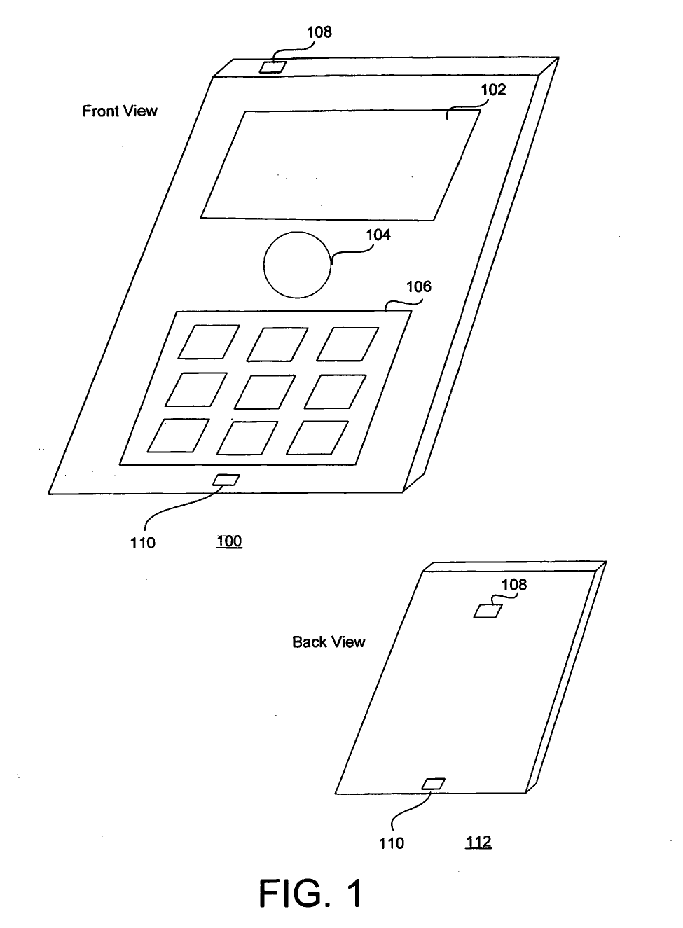

FIG. 1 is an exemplary illustration of a PSD in an embodiment. A PSD 100 in one embodiment can be hand-held and/or wearable with a form factor similar to that of a portable electronic device such as (but not limited to) a cellular phone, digital music player or digital camera. In one embodiment, the PSD housing is a special color that warns criminals of its special purpose. A GPS receiver or other geographic location determination device (e.g., GSM transceiver) is integrated with the PSD and can be used to determine the location, speed and direction of travel of a PSD user. The PSD includes a display 102 (e.g., liquid crystal, light emitting diode, plasma, or other suitable display) which can be used to display status information and messages. By way of a non-limiting example, status information could include location information, battery life, an indication of whether or not the PSD is within range of a receiver, paging/e-mail messages, caller identification, music selections, images, games, and information entered from keypad 106. The keypad (e.g., numeric or alphanumeric) can be used to place phone calls, send pager/e-mail messages, play games, and otherwise allow a user to interact with the device. Specialized ergonomic controls to operate integrated components such as a camera, a digital music player, game player, and/or cellular phone can be located on the keypad or elsewhere on the device and are fully within the scope and spirit of the present disclosure.

Panic button 104 or other-touch sensitive device can be used to activate the safety features of the PSD. By way of a non-limiting example, the user can depress the panic button once to begin recording sound through microphone 110 and optionally begin recording still or moving images (e.g., MPEG-4) through a digital camera having lens 108. If the user believes that he or she is in danger, additionally pressing the panic button one or more times in succession can activate an emergency channel wherein the user's current location, speed, direction of travel and some or all of the collected sound and/or image information can be transmitted (e.g., as one or more data packets on a mobile telephone, such as a cellular telephone, a mobile telephone network or a mobile LAN or other wireless network) from the PSD to a secure relay wherein help can be automatically summoned on behalf of the user. In another embodiment, the panic feature can be activated with a voice command or by a sound, or by applying pressure to the surface of a PSD. It will be appreciated that the present disclosure is not limited to any one particular method of activating the panic feature of the PSD. In one embodiment, the information can be encrypted and/or compressed prior to or during transmission. If the PSD cannot reach a relay due to its being out of range or for some other reason, the PSD will buffer the information and transmit it once it is able to establish contact with the relay.

In another embodiment, the PSD can be integrated with other devices/form factors such as wristwatches, digital cameras, digital music players, PDAs, Pocket PCs or other suitable devices. In yet another embodiment, the PSD can be integrated into a self-defense weapon. By way of a non-limiting example, the PSD can be incorporated into a conducted energy weapon such as a Tasar™, available from Taser International, Inc. of Scottsdale, Ariz. In such an embodiment, the panic button could be ergonomically located on the weapon handle or integrated with the trigger mechanism. Likewise, the digital camera lens and microphone could be positioned on the weapon's barrel so that by pointing the weapon at an attacker, the weapon would be able to record the attacker's image and voice. This would allow the user to both summon help and provide a means for self-defense.

In another embodiment, a PSD can include one or more tamper-resistant or tamper-proof bracelets, anklets, straps or harnesses to secure the PSD to a person. In this way, small children who might be libel to remove and lose the PSD will be thwarted. Similarly, a criminal probation program can use a PSD to track an offender's location without the risk that the offender will remove the device. In one embodiment, if the PSD is removed, the PSD can automatically transmit a message to a relay indicating this event.

In another embodiment, the PSD can include a biometric identification device that can be used to authenticate its user. In one embodiment, the biometric identification device can be integrated into the panic button or voice recognition system. Such biometric sensing devices can include, but are not limited to, finger print detection, voice recognition, retinal scanning (e.g., via the camera lens), blood or saliva analysis, facial feature analysis, vein analysis, and other suitable automated methods of recognizing a person. It will be appreciated by those of skill in the art that many more biometric identification methods which are not discussed herein are nonetheless fully within the scope and spirit of the present disclosure. In one embodiment, an offender may be required by their probation officer to periodically perform biometric identification to ensure that the offender has the device on their person.

PSD System

Once an individual activates the panic feature of a PSD, the PSD transmits information including the individual's location to a relay system. The relay system in turn automatically summons help for the individual by relaying the information to a party that can respond to the emergency (e.g., police, ambulance). In addition, the relay system can encrypt and/or digitally sign the information and store it in a database. If the relay does not receive confirmation that assistance is or will be provided to the individual, it can automatically contact other parties according to an escalation strategy. This provides a safety net should the primary emergency response fail.

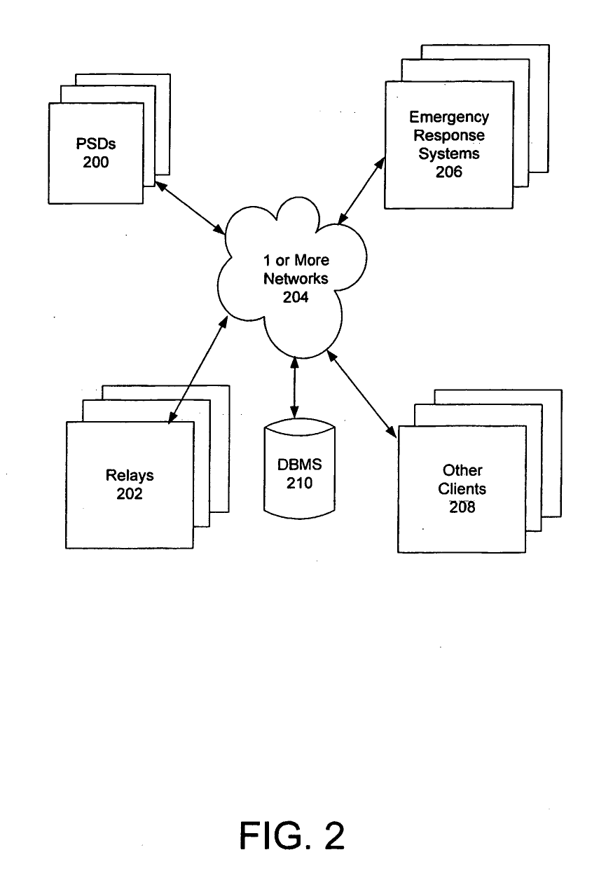

FIG. 2 is an exemplary PSD information relay system in an embodiment. Although this diagram depicts objects/processes as logically separate, such depiction is merely for illustrative purposes. It will be apparent to those skilled in the art that the objects/processes portrayed in this figure can be arbitrarily combined or divided into separate software, firmware and/or hardware components. Furthermore, it will also be apparent to those skilled in the art that such objects/processes, regardless of how they are combined or divided, can execute on the same computing device or can be distributed among different computing devices connected by one or more networks or other suitable communication means.

One or more PSDs 200 can transmit information in an emergency (e.g., when the panic feature is activated) to one or more secure relay servers 202 via one or more public or private networks 204. By way of a non-limiting example, a network can include one or more of satellite, cellular (e.g., CDMA, GSM, UMTS), local area wireless (e.g., Wi-Fi), Ethernet, token ring, Internet and ATM networks. In one embodiment, a relay can associate the PSD's transmitted location, speed, direction of travel, and the PSD's sound/image/video/movie information with time stamps and/or electronic signatures in order to provide a tamper-proof record of the information. In another embodiment, a relay can be integrated into a network access point, such as a cellar base station, satellite uplink, or point-of-presence, such that PSD information is made tamper-proof before it enters a network at large. Multiple relays can be organized in clusters or grids to provide automatic load balancing and fail-over as is well known in the art wherein if one relay server fails or is busy, a second relay server can pick up where the first one left off. The relays can share a DBMS (database management system) 210 to persist the information received from PSDs.

In one embodiment and by way of example, upon receiving information from a PSD, a relay can automatically notify one or more emergency response systems 206 (e.g., police, ambulance). Alternatively or in addition to contacting the emergency response systems, the relay can also automatically contact one or more other clients 208 (e.g., a child's parents, a friend or spouse, an employer, etc.). The notification can take many forms including, but not limited to, an electronic message sent over the one or more networks, an automated voice message sent via a telephone network or via VoIP, e-mail message, an automatically placed 911 call, a facsimile, and/or a pager message. The notification can include a user's current location, direction of travel, speed, and/or voice/image/video/movie data recorded by the PSD. In another embodiment, the information can include medical or police records. In one embodiment, the notification delivery can be escalated automatically if an acknowledgement of its receipt is not received by the relay. For example, if an electronic message is sent but is not acknowledged within a certain time frame, the relay can attempt to automatically contact the parties through alternate and/or higher priority paths (e.g., via e-mail, telephone, etc.) until a confirmation that help is on the way is received.

In another embodiment, a PSD can periodically provide its location information to a relay either when requested to by the relay or in an autonomous fashion. By way of a non-limiting example, the PSD can keep track of its location over time and provide this information every so often to the relay. In this way, relays are able to keep up-to-date on the whereabouts of all PSD users. For example, parents may want to track their child's comings and goings throughout the day. Likewise, a probation officer may need to know exactly where an offender under his charge has been.

PSD System User Interface

A UI visually depicts the path of a PSD on a satellite or street map as well as a projected path based on the current direction and travel speed of the PSD. This allows emergency personal or other interested parties to quickly ascertain where an individual with a PSD is and where they might be going. In addition, the UI provides the ability to playback images/movies/videos and sounds that were recorded on the PSD at given geographic locations. Besides providing this information, the UI permits messages to be sent to the PSD (e.g., a page or voice message) as well as configuration information which can control feature activation on the PSD. The UI also has the capability of configuring relay escalation strategies.

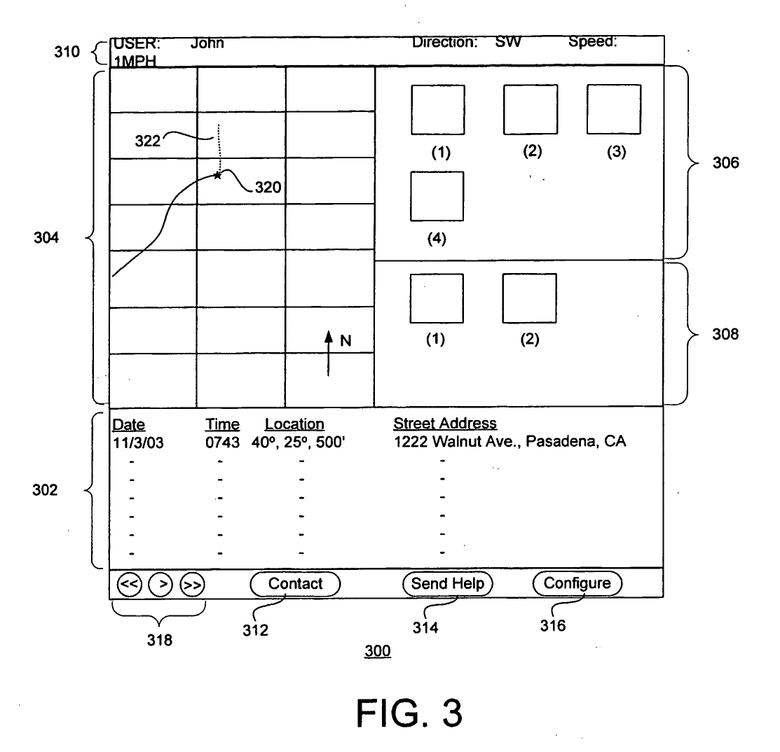

FIG. 3 is an illustration of an exemplary UI in an embodiment. In addition to providing emergency services, a relay allows emergency services and other clients to access information including a PSD user's whereabouts and to communicate with a PSD user. In one embodiment, the UI can retrieve information from a relay and/or the DBMS. By way of a non-limiting example, the UI can include one or more of the following: 1) a GUI (e.g., rendered with HTML); 2) an ability to respond to sounds and/or voice commands; 3) an ability to respond to input from a remote control device (e.g., a mobile communications device, such as a mobile telephone such as a cellular telephone, a PDA, or other suitable remote control); 4) an ability to respond to gestures (e.g., facial and otherwise); 5) an ability to respond to commands from a process on the same or another computing device; and 6) an ability to respond to input from a computer mouse and/or keyboard. This disclosure is not limited to any particular UI. Those of skill in the art will recognize that many other UI embodiments are possible and fully within the scope and spirit of this disclosure.

In one embodiment, UI 300 can include a history list 302, a map 304, an image/video/movie file pane 306 and a sound file pane 308. A status bar 310 can display the PSD user's name, current direction of travel and current speed. The history list contains a history of where a user has been. Each row in the list can include a date and time stamp for a location in latitude, longitude, and altitude, and the approximate street address. By default, the list can be automatically sorted so that the most recent information is at the top of the list. Selection of a row in the list can cause the location to be displayed in the map. The map shows the user's current location (“*”), where user has been (solid line) and where it is projected that the user is going 312 (dashed line). In one embodiment, the user's projected path can be based on the user's current direction, speed and prior location(s). The map can be displayed as a street map, a satellite image, or an overlay of a street map on a satellite image. By default, a map of the user's current location is displayed and refreshed each time new location information is received by the relay. If the user has activated the panic button, the relevant row in the history list can be displayed in red or otherwise highlighted to draw attention to it.

Image file pane 306 can contain icons representing still or motion images (e.g., movies/videos) the user captured that are associated with the selected history row. Icons can be scaled versions of the images in the case of still images, or the first or a representative frame in the case of a video/movie. Selection of an image/video/movie icon can cause the image/movie/video to be displayed. The image/movie/video can be displayed in its own window or overlapped on some or all of a map. If the selected icon represents a movie, then controls 318 can be used to play, rewind or fast-forward the movie. By default, selecting a movie icon can cause the movie to play. Sound file pane 308 includes icons representing sounds the user captured that are associated with the selected history row. As with image file icons, a user can select a sound icon and use controls 318 to play, fast forward or reverse. By default, selecting a sound icon causes it to automatically play.

In one embodiment, the UI can allow interaction with a PSD user through one or more relays. This interaction can be accomplished using any number of network protocols and data formats, including but not limited to IP, UDP, TCP/IP, HTTP, HTTPS, POP, VoIP, SOAP, XML, or any other suitable standard or non-standard format/protocol. In one embodiment, a “Contact” button 312 allows a text, voice or video message to be sent to a PSD via a relay on behalf the UI. A “Send Help” button 314 can cause the UI to direct a relay to dispatch emergency services to the PSD user. Finally, the “Configure” button 316 allows commands to be sent to a PSD. By way of a non-limiting example, such commands can include the ability to remotely unlock a tamper-resistant or tamper-proof bracelet or anklet that secures the PSD to a person, the ability to remotely enable/disable the PSD “Panic” button, and the ability to remotely enable/disable any other features of the PSD.

In another embodiment, the “Configure” button allows relay parameters associated with a given PSD to be remotely configured from the UI. One such parameter is the emergency escalation strategy. The escalation strategy allows the specification of a list of parties to contact in any given scenario (e.g., when the user activates the PSD panic button). For each party, a list of prioritized communication paths can be provided. In one embodiment, a communication path can be comprised of a communication medium, an address and a message. Although specific examples of communication mediums are provided, this disclosure is not limited to any particular medium known or to be developed. It will be appreciated that many more communication means are within the scope and spirit of the present disclosure.

If there is more than one party to contact for a given scenario, the relay can attempt to contact all parties in parallel. Although an example of an emergency scenario is provided (i.e., activation of the panic feature), the present disclosure is not limited to any particular scenario. Other scenarios with escalation strategies can include the following:

1. A PSD user fails to authenticate him/herself.

2. A PSD is out of contact of a relay for a given period of time.

3. A PSD with a wrist or ankle locking device is removed.

4. A PSD leaves a predefined geographic area.

5. A PSD enters a predefined geographic area.

Of course, each scenario can have its own escalation strategy. For example, if one of the parties to contact in a given scenario was the local Sheriff, the communication paths for the Sheriff's escalation strategy could appear as given in Table 1 below:

TABLE 1
Exemplary Communication Paths for a Party in an Embodiment

| PRIORITY | PROTOCOL | DESTINATION ADDRESS | MESSAGE |
|---|---|---|---|
| 1 | UDP | 121.33.44.312:5452 | UDP_MSG_23($USER) |
| 2 | VOICE | DIAL 911 | SPEAK(“$USER at |
| | | | $LOCATION.SADDR needs |
| | | | assistance.”) |
| 3 | PAGE | 1-435-483-3884 | $USER at $LOCATION.SADDR |
| | | | needs assistance. Call |
| | | | CALL_IN_NUMBER($USER).”) |
| 4 | POP | sheriff@santaclara.gov | $USER at $LOCATION.SADDR |
| | | | needs assistance. Call |
| | | | CALL_IN_NUMBER($USER).”) |

In one embodiment, a relay will attempt to communicate with a party according to the party's escalation strategy. In this example, the highest priority (i.e., priority 1) communication path to the Sheriff is to send a message as defined by a macro “UDP_MSG_{—}23” to Internet address 121.33.44.312, port 5452 using the UDP protocol. The UDP_MSG_{—}23 macro can create a message that is suitably formatted for reception by a server system under control of the Sheriff. The macro takes as an argument “$USER” variable which is expanded to be the PSD user's name. The macro can use this information in creating its message. Once the message has been created, it is sent by relay to the destination address.

If the message to the party fails using the highest priority communication path, the relay can escalate by attempting the next highest priority path (i.e., priority 2). In this example, the relay would next attempt to deliver an audible voice message by dialing 911 and providing a voice message. The message in this case is created by a “SPEAK” macro, which converts text to speech. The macro takes as its arguments a text string. Variables will be expanded by the relay prior to invoking the macro to include a $USER name and a current street address (per the PSD's location information) as specified by $LOCATION_SADDR. An exemplary expanded string might read: “John Smith at 1234 Main Street in Pasadena, Calif. needs assistance.”

If the voice message fails (e.g., busy signal or a human at the other end fails to respond to a voice prompt), the relay can further escalate by sending a textual page to phone number 1-435-483-3884 via a “PAGE” macro. The PAGE macro takes as an argument a string, which, in this example, includes a macro “CALL_IN_NUMBER”. CALL_IN_NUMBER provides a unique number for the page recipient to call based on the $USER. In this way, a relay can associate the incoming call with a given $USER. After variables are expanded and CALL_IN_NUMBER has been invoked, the resulting string in this example can read: “John Smith at 1234 Main Street in Pasadena, Calif. needs assistance. Call 1-888-443-3800, extension 432.”

Finally, if the page is not returned within a predefined time limit, the next escalation strategy (i.e., 4) is attempted. In this example, an e-mail message will be sent to the POP address sheriff@cleveland.ohio.gov. Here, the message is the same as for the page. By way of a non-limiting example, if the e-mail message delivery fails, or is not viewed or responded to in a predefined time limit, the relay can further escalate or, if there are no more communication paths for this party, the relay can start over with the first communication path.

PSD Device

In certain embodiments, a PSD device can have an open and extendable architecture. Components can share a logical bus through which they exchange asynchronous or synchronous messages. Components also can provide standard interfaces through which other components can access their functionality. Standard interfaces can hide the particulars of a given hardware implementation and allow PSD hardware to adapt over time without requiring changes to component interaction. While each component can operate independently of the others, a central monitor component can be used to coordinate primary functions, such as how the PSD responds to activation of the panic feature.

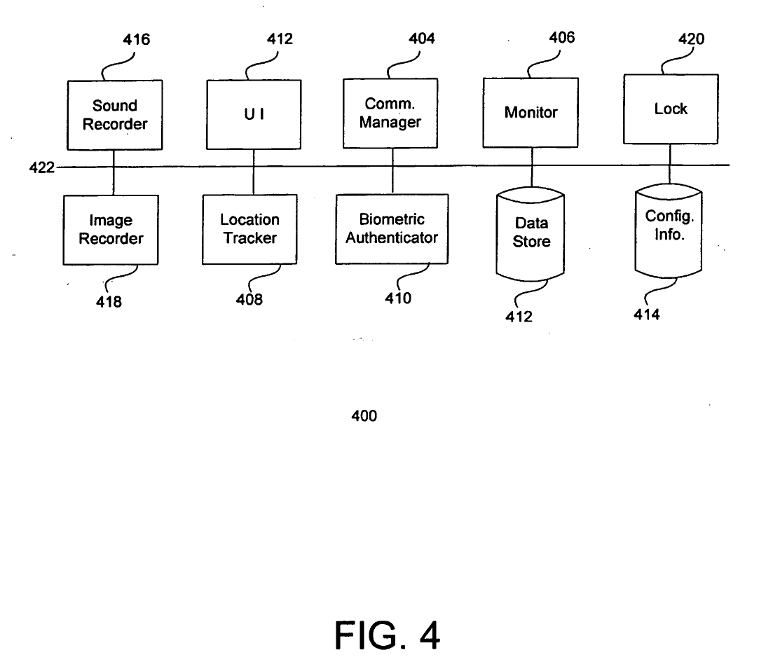

FIG. 4 is an exemplary illustration of a personal safety device system in an embodiment of the present disclosure. Although this diagram depicts subsystems as logically separate, such depiction is merely for illustrative purposes. It will be apparent to those skilled in the art that the subsystems portrayed in this figure can be arbitrarily combined or divided into separate software, firmware and/or hardware components. Furthermore, it will also be apparent to those skilled in the art that such components, regardless of how they are combined or divided, can execute on the same computing device or can be distributed among different computing devices connected by one or more networks or other suitable communication means.

System 400 has an open architecture that allows for infinite expandability. The system is composed of one or more components that implement a common communication mechanism. Component communication can be facilitated through a logical message bus 422 or other paradigm that allows components can send and receive asynchronous messages. In one embodiment, the message bus can be based on the JMS API available from Sun Microsystems, Inc. of San Jose, Calif. JMS is a messaging standard that allows application components to create, send and receive messages. The message bus allows individual components to take actions based on messages they receive and, likewise, to drive the action of other components by sending messages. In one embodiment, a message can include a code identifying the source component of the message, the message type, and optional parameters. Such a flexible system allows for easy integration with new devices (e.g., PDAs, cell phones, music players, digital cameras, computer games) as these technologies evolve.

The system includes a location tracker component 408 which can continuously or periodically receive location information from a compact GPS receiver or other device for determining geographic location (not shown) and store said information in persistent data store 412. In one embodiment, the persistent data store can be a static RAM, a flash RAM, memory stick, compact CD-ROM, or any suitable write-able, non-volatile memory. The location tracker can receive messages that correspond to requests for current or historical position information and respond with the requested information. In one embodiment, the location tracker has a standard hardware interface, which allows any location determination device that conforms to the interface to provide location information to the tracker.

A biometric authenticator component 410 can provide a standard authentication interface for the system components by hiding the particulars of the underlying authentication mechanism. This allows new and developing authentication mechanisms (e.g., finger print detection, voice recognition, retinal scanning, blood or saliva analysis, facial feature analysis, vein analysis, etc.) to be seamlessly adopted without requiring modifications to other system components. In one embodiment, the authenticator can accept requests to perform authentication and can respond with a determination of whether or not the authentication was successful. In one embodiment, the authenticator has a standard hardware interface, which allows any authentication hardware that conforms to the interface to provide authentication information to the authenticator.

UI component 412 can provide a standard interface for obtaining user input (e.g., keypad interaction, panic button, voice recognition, finger and hand articulation, etc.) and for providing visual, audio and other sensor output to the user. In one embodiment, the UI component implements a message interface that allows other components on the message bus to access services related to input events and output functions. By way of a non-limiting example, a component can send a message to the UI component to register to receive input events from, for example, the keypad. Thereafter, whenever the UI component detects input from the keypad, it will send a message and any relevant data to components that have registered to receive this input event. Likewise, a component can send a message to the UI component to cause output on a PSD device, such as a display, speaker, vibrator or other output device. In one embodiment, the UI component has a standard hardware interface that allows any input/output hardware that conforms to the interface to provide authentication information to the authenticator.

Communication manager component 404 can provide a standard interface for sending and receiving information over one or more communication mediums (e.g., cellular, satellite, Wi-Fi, pager, or other suitable medium). The communication manager can offer connected, connectionless, reliable and/or unreliable communication channels. In one embodiment, the communication manager implements a message interface that allows other components on the message bus to access these services. By way of a non-limiting example, a component can send a message to: open a communication channel of with a given destination; send a message over the channel; register to receive a message when information is received on the channel; register to receive a message when information transmittal fails; and set transmission parameters such as retry count, message length, compression, and encryption. In one embodiment, the communication manager has a standard hardware interface, which allows any communication hardware that conforms to the interface to integrate with the manager.

In one embodiment, sound recorder component 416 and image recorder component 418 provide sound and image/movie/video recording capabilities, respectively. As with the other components, components 416 and 418 can provide services for capturing sound and images to other components through a message interface. In one embodiment, the components can store captured information in the data store. In another embodiment, the components can provide captured sounds/images/movies/videos in a message. Both components can also implement hardware interfaces to allow any number of hardware devices (e.g., microphones, digital still/video cameras) to be easily plugged into the system. In another embodiment, components 416 and 418 can be integrated into a single component.

The monitor component 406 can coordinate the activities of other components. Through its message interface, it can receive events from other components such as the UI component and the communication manager. Based on the events it receives, the monitor can take action. In one embodiment, if the monitor receives an event indicating that the panic feature has been activated, the monitor can open a channel to a relay (if one is not already open), begin recording sound and/or images/movies/videos, and begin transmitting this information along with location information in the data store. If a channel cannot be opened (e.g., the PSD is out of range of a network connection), the monitor can store the information for transmittal later when a connection can be established.

In another embodiment, the monitor can periodically send location information to a relay, either autonomously or in response to a request for such information from the relay. The monitor can also accept messages from the relay pertaining to the PSD's configuration parameters. In one embodiment, configuration information scan be stored in the data store or persistent storage 414. By way of a non-limiting example, these parameters can include feature enablement/disablement and/or one or more geographic zones. When a PSD enters or exits a given geographic zone, the monitor can send a indication of this to a relay. In this way, the relay can trigger associated scenarios.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a storage medium (media) having instructions stored thereon/in which can be used to program a computer to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing descriptions of embodiments of the present invention have been provided for the purposes of illustration and description. It is not intended to be exhaustive or to limit the invention to the precise forms disclosed. Many modifications and variations will be apparent to the practitioner skilled in the art. Embodiments were chosen and described in order to explain principles of the invention and its practical application, thereby enabling others skilled in the art to understand the invention, the various embodiments and with various modifications that are suited to the particular use contemplated. All of those modifications are considered to be part of this invention.

What is claimed:

1. A method for summoning help, comprising:
biometrically identifying a user; and
transmitting information over a wireless network in response to a first user action, wherein the information includes the geographic location of the user.

2. The method of claim 1 wherein;
the information includes at least one of
text;
a sound;
an image; and
a video/movie.

3. The method of claim 1 wherein:
the information is transmitted by a device that is securely attached to the user.

4. The method of claim 1 wherein:
a portable device is used to transmit the information; and wherein the portable device is integrated with at least one of
a mobile telephone;
a digital camera;
a computer game;
a digital music player;
a personal digital assistant; and
a GPS receiver.

5. The method of claim 1, further comprising:
automatically summoning help in response to receipt of the transmitted information.

6. The method of claim 1 wherein:
a portable device is used to transmit the information,
wherein the portable device can receive a message, and
wherein the message can include at least one of
texts
a sound;
an image; and
a video/movie.

7. The method of claim 1 wherein:
the information can be transmitted over at least one of
a wireless local area network;
a wireless wide area network;
a cellular network;
a satellite network;
a Wi-Fi network; and
a pager network.

8. The method of claim 1, further comprising:
receiving the information; and
rendering the information tamper-proof.

9. The method of claim 1 wherein:
at least one of the following devices is activated in response to a second user action:
a sound recorder,
an image recorder; and
a video/movie recorder.

10. A method for summoning help, comprising:
transmitting information over a wireless network in response to a first user action;
wherein the information includes the geographic location of a user; and
wherein the information can include at least one of
text information;
sound information;
image information, and
video/movie information.

11. The method of claim 10, further comprising biometrically identifying the user.

12. The method of claim 10, wherein said information is transmitted by a device that is securely attached to the user.

13. The method of claim 10 wherein
a portable device is used to transmit the information; and
wherein the portable device can be integrated with at least one of a mobile telephone;
a digital camera;
a computer game;
a digital music player;
a personal digital assistant; and
a GPS receiver.

14. The method of claim 10, further comprising automatically summoning help in response to receipt of the transmitted information.

15. The method of claim 10 wherein:
a portable device is used to transmit the information;
wherein the portable device can receive a message; and
wherein the message can include at least one of text;
a sound;
an image; and
a video/movie.

16. The method of claim 10 wherein the information can be transmitted over at least one of:
a wireless local area network,
a wireless wide area network;
a cellular network;
a satellite network;
a Wi-Fi network; and
a pager network.

17. The method of claim 10, further comprising:
receiving the information; and
rendering the information tamper-proof.

18. The method of claim 10 wherein:
at least one of the following devices is activated in response to a second user action:
a sound recorder;
an image recorder; and
a video/movie recorder.

19. A method for locating a person, comprising:
accepting information from a portable device on the person wherein the information includes a current location of the person;
providing the information to a user interface wherein the user interface can depict the geographic location of the person,
wherein the user interface can depict a predicted travel path of the person based on the information.

20. The method of claim 19 wherein:
the information includes at least one of
text;
a sound;
an image; and
a video/movie.

21. The method of claim 19 wherein:
the portable device can be integrated with at least one of
a mobile telephone;
a digital camera;
a computer game;
a digital music player;
a personal digital assistant; and
a GPS receiver.

22. The method of claim 19, further comprising automatically summoning help in response to receipt of the transmitted information.

23. The method of claim 19, further comprising:
sending a message to the person via the portable device in response to user interaction with the user interface
wherein the message can include at least one of
text;
a sound;
an image; and
a video/movie.

24. The method of claim 19 wherein:
the information can be transmitted over at least one of
a wireless local area network;
a wireless wide area network;
a cellular network;
a satellite network;
a Wi-Fi network; and
a pager network.

25. The method of claim 19, further comprising rendering the information tamper-proof.

26. The method of claim 19, further comprising automatically summoning assistance for the person in response to user interaction with the user interface.

27. The method of claim 19, further comprising remotely configuring the device from the user interface.

28. The method of claim 19, further comprising biometrically authenticating the person's identity.

29. A portable personal safety device (PSD), comprising:
a location tracker capable of determining a current location of the PSD;
a communication manager capable of transmitting information including the current location and at least one of
text;
a sound;
an image;
a video;
a movie; and
a monitor capable of causing the transmission in response to a user action.

30. The device of claim 29, further comprising a biometric authenticator capable of authenticating the identity of a PSD user.

31. The device of claim 29 wherein the PSD will not operate unless the identity of a PSD user is authenticated.

32. The device of claim 29 wherein the communication manager is capable of transmitting and receiving information over at least one of the following networks
a wireless local area network;
a wireless wide area network;
a cellular network;
a satellite network;
a Wi-Fi network; and
a pager network.

33. The device of claim 29, further comprising means for securing the PSD to a person.

34. The device of claim 29 wherein the PSD can be integrated with at least one of;
a mobile telephone;
a digital camera;
a computer game;
a digital music player;
a personal digital assistant; and
a GPS receiver.

35. The device of claim 29 wherein the transmitted information is automatically relayed to a party that can provide assistance to a user of the PSD.

36. The device of claim 29, further comprising a system capable of receiving the transmitted information, wherein the system is capable of rendering the information tamper-proof.

37. A personal safety system, comprising:
a portable personal safety device (PSD) capable of transmitting a request for help in response to a user action wherein the request includes a current location of the PSD and at least one of:
text;
sound information;
image information; and
video/movie information, and
a relay capable of accepting the request.

38. The system of claim 37 wherein the PSD is capable of biometrically authenticating the identity of a PSD user.

39. The system of claim 37, further comprising a second system capable of receiving the request and rendering information in the request tamper-proof.

40. The system of claim 37 wherein the relay is capable of automatically summoning help based on the request.

41. The system of claim 40 wherein the relay is capable of using multiple communication paths to summon help.

42. The system of claim 37 wherein the relay is capable of rendering information in the request tamper-proof.

43. The system of claim 37, further comprising a user interface (UI).

44. The system of claim 43 wherein the UI graphically renders a current location and projected location of a PSD user.

45. The system of claim 43 wherein the UI is capable of sending a message to a PSD user via the PSD.

46. The system of claim 43 wherein the UI is capable of summoning help on behalf of a PSD user.

47. The system of claim 43 wherein the UI is capable of remotely configuring the PSD.

48. A machine readable medium having instructions stored thereon that when executed by a processor causes a system to:
transmit information over a wireless network in response to a first user action,
wherein the information includes the geographic location of the user; and
wherein the information can include at least one of
text;
sound information;
image information; and
movie/video information.

49. The machine readable medium of claim 48 wherein:
a portable device is used to transmit the information; and
wherein the portable device can be integrated with at least one of
a mobile telephone;
a digital camera;
a computer game;
a digital music player;
a personal digital assistant; and
a GPS receiver.

50. The machine readable medium of claim 48, further comprising instructions that when executed by a processor cause the system to:
automatically summon help in response to receipt of the transmitted information.

51. The machine readable medium of claim 48 wherein:
a portable device is used to transmit the information;
wherein the portable device can receive a message; and
wherein the message can include at least one of
text;
a sound;
an image; and
a video/movie.

52. The machine readable medium of claim 48 wherein:
the information can be transmitted over at least one of
a wireless local area network;
a wireless wide area network;
a cellular network;
a satellite network;
a Wi-Fi network; and
a pager network.

53. The machine readable medium of claim 48, further comprising instructions that when executed by a processor cause the system to:
receive the information; and
render the information tamper-proof.

54. The machine readable medium of claim 48 wherein:
at least one of the following devices is activated in response to a second user action:
a sound recorder;
an image recorder; and
a video/movie recorder.

55. A computer data signal embodied in a transmission medium, comprising;
a code segment including instructions to transmit information over a wireless network in response to a first user action;
wherein the information includes the geographic location of the user; and
wherein the information can include at least one of
text;
sound information;
image information; and
video/movie information.

56. The computer data signal of claim 55 wherein:
the information is transmitted by a device that is securely attached to the user.

57. The computer data signal of claim 55 wherein:
a portable device is used to transmit the information; and
wherein the portable device can be integrated with at least one of:
a mobile telephone;
a digital camera;
a computer game;
a digital music player;
a personal digital assistant; and
a GPS receiver.

58. The computer data signal of claim 55, further comprising:
a code segment including instructions to automatically summon help in response to receipt of the transmitted information.

59. The computer data signal of claim 55 wherein:
a portable device is used to transmit the information;
wherein the portable device can receive a message; and
wherein the message can include at least one of
text;
a sound;
an image; and
a video/movie.

60. The computer data signal of claim 55 wherein:
the information can be transmitted over at least one of:
a wireless local area network;
a wireless Wide area network;
a cellular network;
a satellite network;
a Wi-Fi network; and
a pager network.

61. The computer data signal of claim 55, further comprising:
a code segment including instructions to receive the information; and
a code segment including instructions to render the information tamper-proof.

62. The computer data signal of claim 55 wherein:
at least one of the following devices is activated in response to a second user action:
a sound recorder;
an image recorder; and
a video/movie recorder.

63. A personal safety device, comprising:
means for identifying a user;
means for initiating a signal, wherein said signal comprises position of said device and one or more of: 1) a personal identifying characteristic; 2) a sound signal; 3) an image signal; and 4) a video/movie signal; and
means for transmitting said signal.

64. The device of claim 63, wherein said signal includes means for preventing tampering with said signal.

65. The device of claim 63, wherein said signal further comprises a time stamp.

66. The device of claim 63, further comprising means for warning.

67. A method for summoning help, comprising:
means for biometrically identifying a user;
means for transmitting information over a wireless network in response to a first user action,
wherein the information includes means for locating the user.

68. A system for summoning help, comprising:
a device comprising:
an actuating component
a signal for biometrically identifying a user;
a signal for identifying the geographic position of said device; and
a memory device for storing said signal for biometrically identifying
and identifying the position of said device;
a transmitter for transmitting information over a wireless network; and
a receiver of said information.

69. The system of claim 68, wherein said information further comprises a time stamp.

70. The system of claim 68, wherein said device further comprises at least one of a sound receiver and a camera.

71. The system of claim 68, wherein said information is tamper-proof.

72. The method of claim 4, wherein the portable devise further comprises a display capable of displaying status information and messages.

73. The method of claim 4, wherein the portable devise further comprises ergonomic controls capable of communicating status information about the receiver.

74. The method of claim 72 or 73, wherein the status information can indicate that the wireless transmitter is within range of a receiver and has been activated.

75. The method of claim 74, wherein the status information can indicate that the wireless transmitter has transmitted the information summoning emergency services.

76. The method of claim 9, wherein the second user can activate and deactivate the wireless transmitter sound or image recording.

77. The method of claim 76, wherein the second user can periodically activate and deactivate the transmission of the sound or image recording.

78. The method of claim 77, wherein the second user can record the transmitted sound or image.

79. The method of claim 78, further comprising storing the recorded sound or image wherein one or both of the device and the second user can store the recorded sound or image.

80. The method of claim 9, wherein the second user can periodically monitor the geographic location.

81. The method of claim 77, wherein the second user can time stamp the stored transmissions.

82. The method of claim 9, wherein the second user can control actions of the device by sending codes back to the device.
